(19) United States
(12) Patent Application Publication
(10) Pub. No.: US 2004/0203643 A1
(43) Pub. Date: Oct. 14, 2004

(54) Communication device interaction with a personal information manager

(76) Inventors: Kulvir Singh Bhogal, Fort Worth, TX (US); Nizamudeen Ishmael JR., Austin, TX (US); Mandeep Singh Sidhu, Pflugerville, TX (US)

Correspondence Address: Marilyn Smith Dawkins, Intellectual Property Law Department, International Business Machines Corp, 1140 Burnet Road, Austin, TX, 78758, US

(21) Appl. No.: 10/171,584

(22) Filed: Jun. 13, 2002

(51) Int. Cl. H04M 11/10

(52) U.S. Cl. 455/414.1; 455/412.1

(57) ABSTRACT

Apparatus and methods for providing customized notification of an incoming communication, or other occurrence, directed toward a personal communication device according to data included in a personal information manager is disclosed. PIM data can include a predetermined schedule of events and also include reference to a source of a communication. The schedule of an event can include a time and date of a calendar event. Notification, such as a ring, or vibration, of a cellular phone, can be customized according to the PIM data. Customization can include modifying, delaying or negating a notification of an incoming communication according the PIM data, such as a source of a communication and a schedule of calendar events set forth by a user. A customized response can also be provided to the originator of the communication.

### CROSS REFERENCE TO RELATED APPLICATION

This application cross references the application entitled “Customized Notification” filed concurrently with this application, and bearing the Express Mail Number ______.

### BACKGROUND

This invention relates generally to an apparatus and method for specifying a type of notification to be implemented on a personal communication device. In particular, embodiments of the present invention relate to specifying a type of notification to be implemented on a personal communications device, such as a cellular phone, personal digital assistant (PDA) and the like, according to data input by a user.

An increase in the use of personal communications devices (PCD) has presented new challenges for a user of such a device. The portable nature of a PCD allows for the PCD to be with a user at all times. Typically a signal, such as a ring or an alarm is utilized to beckon a user to the PCD in order to respond to an incoming call or message, or an alert that a scheduled appointment is imminent. A PCD may allow a user to choose from a variety of signals, including different tones or patterns of tones that will sound to signal an incoming message or announce an event. The tones can be simple patterns or emulate melodies.

Typically, the signal is indiscriminate, and often sounds at inappropriate times, such as when engaged in a meeting or other event. Although it is known for a user to be able to silence a PCD, or to implement a vibrating notification, it is often inconvenient for the user to constantly modify a notification setting, such as a telephone ring, in response to circumstances as they arise. In addition, a user may want to receive one or more communications, such as an emergency communication or call from an important client, but not be interrupted by other communications.

However, it may be difficult for the user to determine who is calling without responding to the PCD. In essence, a user can become tied to the responsibility of constantly attending to the PCD.

Therefore, it would be advantageous to provide a method and apparatus that overcame the drawbacks of the prior art. In particular, it would be desirable to provide a method and apparatus that allows a user to specify what rules will govern notification of an incoming communication or of a pending appointment.

### SUMMARY

Accordingly, embodiments of the present invention provide apparatus and methods for automatically responding to an incoming communication on a personal communication device, such as a cellular phone, personal digital assistant, and the like. Information descriptive of a communication originator, as well as information relating to a calendar event can be entered into a data structure.

An indication of an incoming communication can be received and a customized notification relating to the incoming communication can be enabled, wherein the notification is customized according to the calendar event and/or the communication originator. The indication of an incoming communication can include a designation of a communication originator associated with the incoming communication, such as for example, a caller ID or e-mail address.

In another aspect, a calendar event can also be associated with a particular event type, wherein a particular notification is utilized according to event type.

A personal communication device can include, for example, a cellular phone or a personal digital assistant and an incoming communication can be in the form of a voice call or an e-mail. A customized notification that is generated can include a ring with an adjustment to one or more of a) ring volume b) ring tone and c) ring pattern. A customized notification that is generated can also include an audio message generated via a text to speech engine, such as for example, an identifying name and telephone number. Customized notification can also include providing no indication of notification, such as for example no ring or vibration. In another aspect, a customized response to an incoming communication can be associated with a communication originator. The customized response can be provided subsequent to receipt of an indicator of an incoming communication. The customized response to an incoming communication can include, for example, conveying a time and place of a current appointment for a user to whom a communication is directed.

Embodiments can include receiving an identifier, such as a personal identification number and/or password from a communication originator prior to conveying information relating to the user being contacted.

Embodiments of the present invention can also include methods, systems, apparatus, executable software, and data signals implementing inventive concepts. The data signal can be operative with a computing device, and executable software can be embodied on a computer readable medium.

Various features and embodiments are further described in the following figures, description and claims.

### DESCRIPTION OF THE DRAWINGS

FIG. 1 illustrates a block diagram illustrating major components included in embodiments of the present invention.

FIG. 2 illustrates components of a system that can be utilized while implementing embodiments of the present invention.

FIG. 3 illustrates a flow of exemplary steps that can be executed while implementing embodiments of the present invention.

FIG. 4 illustrates a flow of exemplary steps that can be executed to determine if notification should be generated according to a profile.

FIG. 5 illustrates an exemplary data structure that can be utilized in a database implementing embodiments of the present invention.

FIG. 6 illustrates an exemplary GUI that can be utilized while implementing embodiments of the present invention.

### DETAILED DESCRIPTION

Apparatus and methods are provided for customized notification of an incoming communication, or other occurrence, directed toward a PCD according to data included in a personal information manager (PIM). The PIM data can include a predetermined schedule of events and also include reference to a source of a communication. The schedule of an event can include a time and date of a calendar event. Notification, such as a ring of a cellular phone, can be customized according to the PIM data. Customization can include modifying, delaying or negating a notification of an incoming communication according the PIM data.

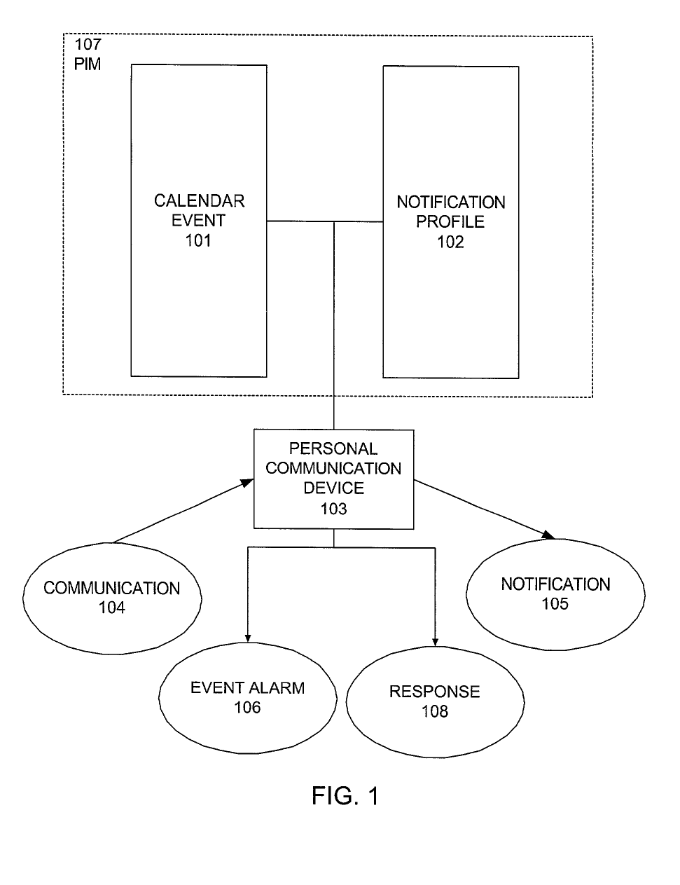

Referring now to FIG. 1, basics components that can be included in the present invention are illustrated. A PCD 103 can receive a communication 104, provide notification 105 of the received communication 104, provide an alarm 106 to announce an event 101, or other function. The PCD 103 can also interact with a personal information manager (PIM) 107 to access information contained within the PIM 107.

A PCD can include, for example, a cellular telephone, PDA, pager, or other device capable of being carried by a user and utilized to communicate with a person or automated facility. A PCD can also include a device with any combination of features previously associated with one or another type of communication device, integrated into one device. An example of a PCD with integrated features can include, for example, a cellular phone with an electronic calendar capability.

An incoming communication can include, for example: a telephone call; an e-mail message or other text message, including instant messaging and the like; a voice message; a page; or other type of communication. Other occurrences can include, for example, an alert signaling a pending appointment, or other scheduled event recorded in the PCD 103.

A PIM 107 can be utilized to receive and store information relating to a user's schedule and contacts. The PIM 107, or other program that can manage an automated calendar, can serve as a data structure into which a list of calendar events 101 can be input by a user. A calendar event 101 can include data descriptive of a time, date and duration for an occurrence with some significance to the user. A typical calendar event 101 can include therefore, for example: an appointment, a meeting, a conference, a work session, a social engagement, a performance, or other occurrence to which a user may wish to commit. Supportive information that can be entered with a calendar event 101 can include, for example: people or entities involved; a location; a purpose for the event; or other information related to a calendar event 101.

The PIM 107 can also include a data structure into which notification 105 preferences can be entered, wherein a notification 105 includes the means by which a PCD 103 signals to a user that an incoming communication is pending. The data structure, such as a notification profile 102, can include, for example, one or more notification preferences that are to be associated with a calendar event 101. For example, if a calendar event 101 includes a meeting from 10:00 A.M. to 11:00 A.M. a user can specify instructions relating how to provide notification 105 during the scheduled meeting time. Embodiments can include a notification profile 102 that contains a preference of default notification 105 instructions.

User preferences for notification 105 that can be included in a notification profile 102, can include modification to PCD 103 generated signals, such as, for example: adjusting a ring tone; adjusting a ring pattern; adjusting a ring volume; silencing all ringing; providing a vibration indication; providing a visual indication; providing any combination of ringing, visual indicators and vibrating indicators; including modified patterns or volumes; or withholding all indication of notification 105.

User preferences for notification 105 included in a notification profile 102 can also include a user entered notification 105, such as, for example: an audio message created with a text to speech engine. An audio message can include, for example, an announcement of a name and number of a caller; a text message indicative of a caller; a notification 105 associated with a group of callers; a notification 105 associated with an urgency level of an incoming communication 104; or other user defined notification.

Embodiments can also include suppressing notification until a predetermined time, such as, for example, a time corresponding with completion of a scheduled event such as a meeting or other appointment.

A notification 105 specified according to a party originating a communication 104 can therefore provide that if a particular party should originate a communication 104, such as a voice call, the PCD 103 can provide a particular notification 105 indicative of the party calling, such as a distinctive ring pattern unique to the originating party. The party originating a communication 104 can be determined, for example, with Caller ID information, via an originating e-mail address or other means of identification which is appropriate for a particular communication type. For example, if a user wishes to always receive a communication from a specific party, such as a family member, or an important client, a particular notification 105 can be utilized to provide an indication unique to a defined party or group of parties.

If information relating to Caller ID is not available, such as, for example, if an originator is traveling or calling from non identifiable phone terminal, embodiments can include an originator being provided with a mechanism for identifying themselves, such as, for example, with an alpha-numeric identifier.

Embodiments can also include implementation of a notification profile 102 that is predicated upon a confirmation of a calendar event 101. Confirmation of the calendar event 101 can include a manual confirmation by a user that a user has arrived at a location specified for the calendar event 101, automated confirmation based upon a receipt of a predefined telephone call, or other mechanism. Manual confirmation can be accomplished via any user interface available, such as, for example, depressing some combination of user keys or buttons, or input into a graphical user interface (GUI).

PIM 107 information can also be utilized to provide a response 108 to a communication 104 originator. Embodiments can include conveying a response 108, which includes information stored in the PIM 107, to a communication 104 originator, wherein the response 108 relates to entries in the PIM 107 for a time period inclusive of a time a related communication 104 is received. For example, if a user has entered data into a PIM 107 indicating that the user will be in a meeting from 9:00 A.M. until 12:00 P.M., and the user receives a telephone call at 10:00 A.M., a text to speech converter can inform the caller that the user has a meeting scheduled from 9:00 A.M. until 12:00 P.M.. If desired, embodiments can also include the PIM 107 conveying information to the caller relating to people or entities involved; a location; a purpose for the event; or other information related to a calendar event 101. Other embodiments can include limiting detailed information conveyed to a communication 104 originator. Limited information may include, for example, conveying only a time period during which the user has a scheduled calendar event 101 or other subset of PIM 107 information.

Embodiments can also include conveying a level of detail relating to PIM 107 information in response to receiving an identifier, such as a personal identification number (PIN) from the communication 104 originator. A PIN can associate a communication 104 originator with a group or level of detail of information to be conveyed. For example, a null or invalid value for a PIN may trigger a response which does not contain any PIM 107 information. A Level One PIN entry, or other quantifier, may trigger a response which includes PIM 107 information with some subset of detail, such as a time period during which the user being contacted has an entered calendar event 101. A Level Two, or other gradation, may trigger a response with all detail the PIM 107 information can convey relating to an event inclusive of a calling time.

Embodiments which include a PIN to determine a level of detail of response can also be include PIM 107 software with a hierarchical structure, such as, for example, a program for managing an organization, such as a sales force contact management program, with shared resources, information and responsibilities. Privileges, or other authority levels, can therefore be ported from, or otherwise related to, hierarchies built into the PIM 107. Embodiments can also include information entered into a PIM 107 which is marked as private, or other designation, which prevents the information from being conveyed to a communication 104 originator. For example, information detailing a personal appointment, such as a medical related appointment, may be marked private and all information kept private.

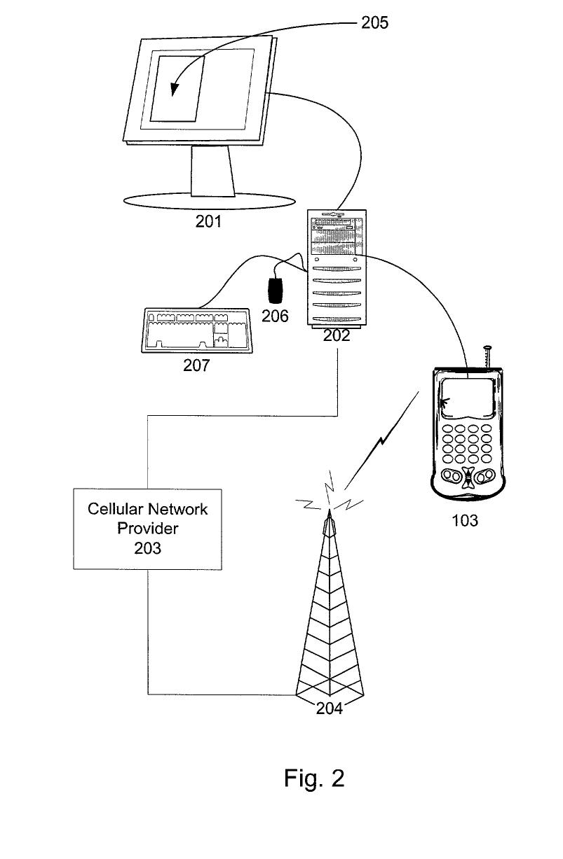

Referring now to FIG. 2, an exemplary system illustrating embodiments of the present invention is shown. The system can include a computing unit 202 containing a processor, memory and storage device, such as a disk drive. The computing unit 202 can be functionally connected to a display 201 and input devices, such as a keyboard 207, a mouse 206 or other input device. The computing unit can also be functionally connected to a PCD 103. Software operative with the computing unit 202 can be utilized to receive input from a user regarding a calendar event 101, as well as a notification profile 102 or details relating to an event alarm 106. Input can be received, for example, via a graphical user interface (GUI) 205 presented on a display 201 or on a PCD 103. Therefore, embodiments can also include input from a user being received into the PCD 103.

Still other embodiments can include information, such as a calendar event 101, notification profile 102, other PIM 107 information, event alarm 106 details or other information being generated by an automated means, such as via a software program running on the computing device or information received from an external source, such as, for example, an event scheduled by another party requesting the participation of the user for a calendar event 101.

A communication 104 can be received at the PCD 103 via a wireless communications network 204, such as, a cellular phone network.

Software associated with a PCD 103 can include executable program code or other software. In some cases, an executable program, such as a Java™ program, may be downloaded from a website available in the Internet and installed on the computing device 202 or the PCD 103. Other implementations include proprietary software installed from a computer readable medium, such as a CD ROM or DVD. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

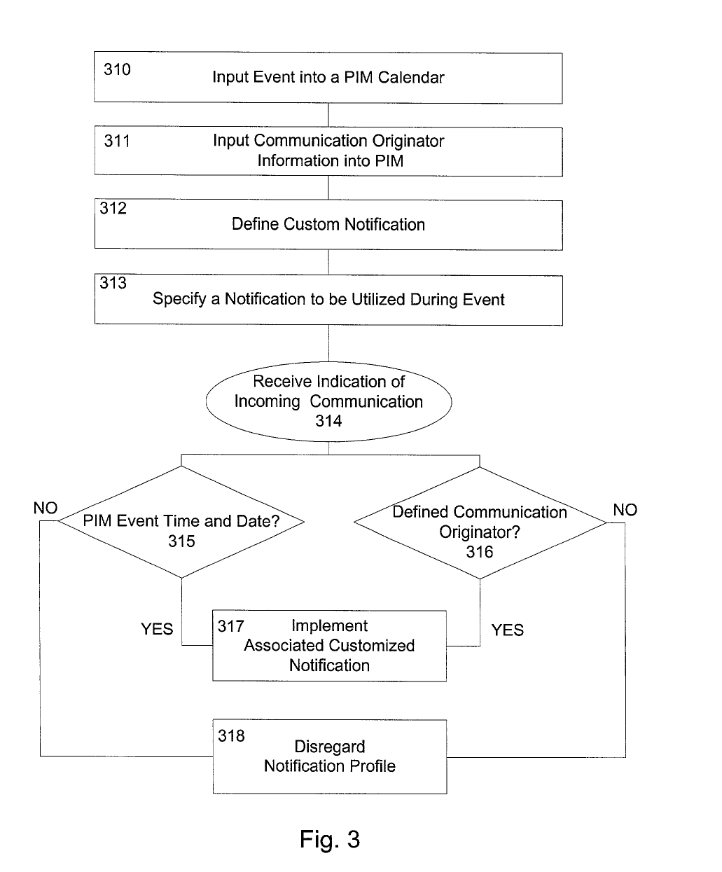

Referring now to FIG. 3, steps that can be executed to implement the current invention can include inputting an event into a schedule, calendar or other vehicle for organizing or tracking events 310. Information relating to one or more communication originators, such as contact information can also be input 311. Embodiments can also include a custom notification being defined 312. A notification to be utilized during a calendar event 101 can be specified 313, such as in a notification profile 102. PIM 107 information and notification specifics can be indicated, for example, by keying information descriptive of the event into a computing device 202 or by entering the information into the PCD 103. If desired, information entered into the PCD 103 and the computing device 202 can be synchronized by a link between the PCD 103 and the computing device 202.

An indication of an incoming communication to the PCD can be received 314. The indication of incoming communication can include, for example, a telephone ring, an e-mail alert, or other indication. An automated process, such as a software program, can determine if the time and date at which the indication of a communication is received correlates with a time and date entered 315 for an event 101.

If the time and date that the communication is received correlate with a time and date indicated for an event 101, a customized notification associated with the calendar event 101 can be implemented 317.

If the time and date that a communication is received does not correlate with a time and date for an event 101, then a notification profile 102 can be disregarded 318.

It can also be determined if a communication originator is defined 316. If the originator is defined, a customized notification can be implemented 317. If the originator is not defined, the notification profile can be disregarded 318.

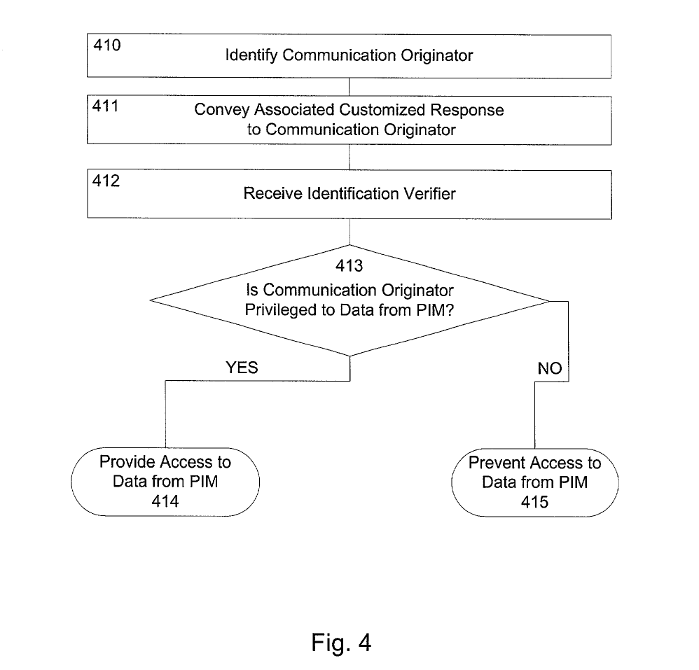

Referring now to FIG. 4, exemplary steps that can be associated with a process for determining whether access to PIM 107 information will be provided are illustrated. The communication originator can be identified 410, such as, for example, via Caller ID data, via an e-mail address, or other identifying means which is appropriate to a particular communication 104. A customized response specified for the communication originator can be conveyed 411. An identification verifier can be received 412 which provides a level of assurance relating to who a caller is. The verifier can include any mechanism or process that delivers a level of assurance of a communication originator commensurate with the sensitivity of the data that will be accessed. Therefore, if the data which will be accessed is highly confidential, a verification mechanism will need to be more secure.

Accordingly, a verifier can include a combination of an identification of the communication 104 originator and an authorization mechanism, such as, for example, a combination of: an alphanumeric code or name; an associated PIN, a password, an encryption key, or other verification means.

Based upon the identification verification, it can be determined if the communication originator is privileged to access PIM 107 information 413. If the communication 104 originator is privileged, access to pertinent PIM 107 data can be provided 414. If the communication 104 originator is not privileged, access to pertinent PIM 107 data can be prevented 415.

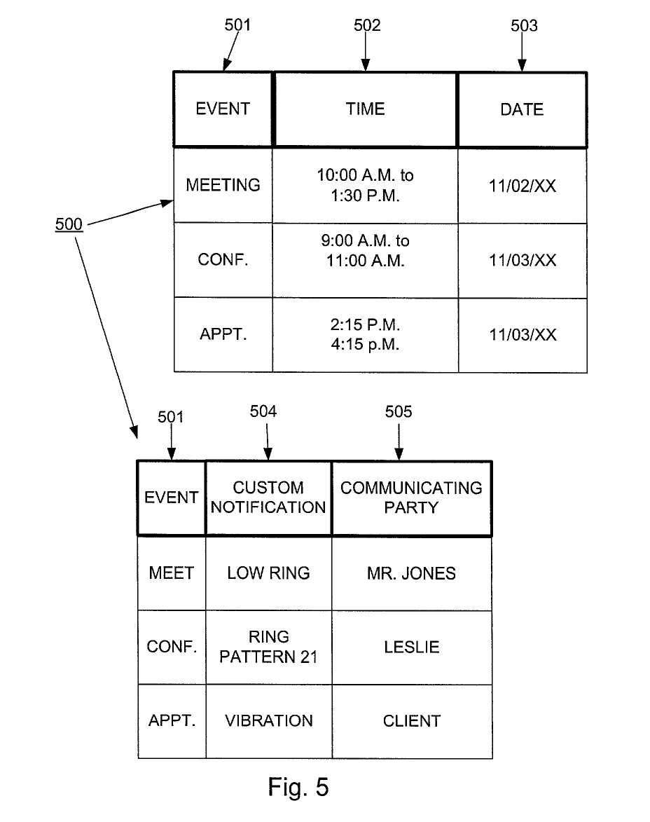

Referring now to FIG. 5, an exemplary data structure 500 is illustrated that can be utilized in a notification system according to the present invention. Data useful for implementing the present invention can include data fields containing: an event description 501; a time associated with an event 502; and a date associated with each event 503. Related data fields can also be linked to other data, for example, by the event data field 501. Related additional fields can include, for example, a customized notification data field 504 with data representative of a specific notification which can be associated with one or more calendar events 101, and a data filed relating to a communicating party 505.

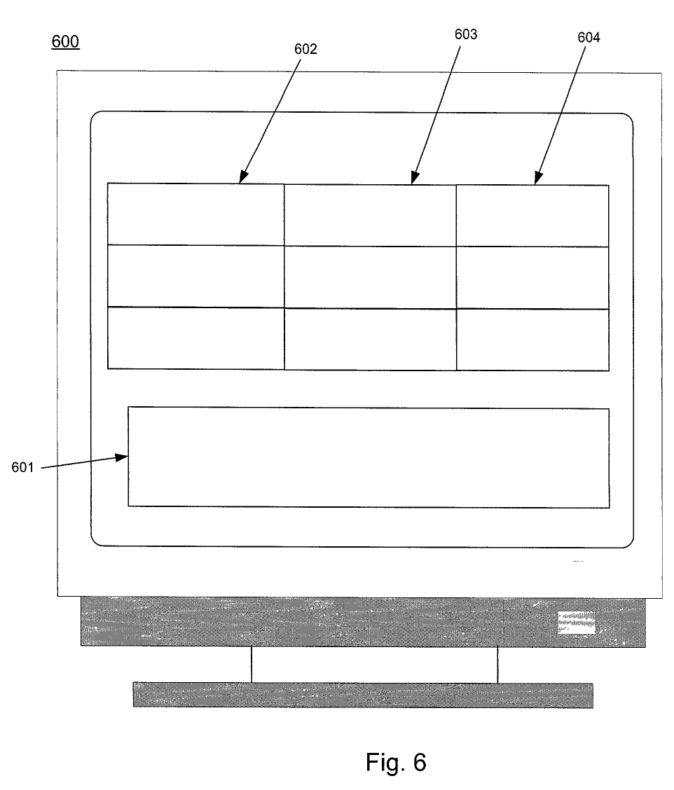

Referring now to FIG. 6, an exemplary GUI 600 for presenting various aspects of the present invention on a display 210 or on a PCD 103 is illustrated. The GUI 600 can include geographic areas of a user interface containing interactive areas for entering an event 602; another geographic area 603 can include interactive areas for indicating a notification profile 102, or specific notification 105 instructions which may be dependent upon a party initiating a communication 104. Still another area of the GUI 604 can include an interactive portion for specifying a party who may initiate a communication 104 that will be associated with a customized notification 105. Information relating to verification of a communication 104 originator can be displayed in still another area of the GUI 601.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. For example, customization of the notification can be accomplished by the PCD 103 at the PCD 103 or by a carrier that provides a communication service to the PCD, such as, for example, a cellular telephone signal provider. Notification software can interact with proprietary calendaring and personal information management software to provide the additional inventive functionality, or be embodied in a stand alone software product. Accordingly, other embodiments are within the scope of the following claims.

What is claimed:

1. A method for automatically responding to an incoming communication on a personal communication device, comprising:
entering information descriptive of a communication originator into a data structure;
entering information relating to a calendar event into the data structure;
receiving an indication of an incoming communication; and
enabling a customized notification relating to the incoming communication, wherein the notification is customized according to a calendar event and a communication originator.

2. The method of claim 1 wherein the indication of an incoming communication comprises a designation of a communication originator associated with the incoming communication.

3. The method of claim 1 further comprising the steps of:
associating a particular notification with a type of calendar event; and
enabling the customized notification according to the associated notification.

4. The method of claim 1 wherein the data structure comprises a personal information manager.

5. The method of claim 1 wherein the personal communication device comprises a cellular phone.

6. The method of claim 1 wherein the personal communication device comprises a personal digital assistant.

7. The method of claim of claim 1 wherein the customized notification generated comprises a ring with an adjustment to one or more of a) ring volume b) ring tone and c) ring pattern.

8. The method of claim 1 additionally comprising the steps of:
associating a customized response with the communication originator; and
providing a customized response subsequent to receiving an indication of an incoming communication.

9. The method of claim 8 wherein the incoming communication comprises a voice call.

10. The method of claim 8 wherein the customized response to an incoming communication comprises conveying to the originating party information stored in a personal information manager associated with a user to whom the incoming communication is directed.

11. The method of claim 9 additionally comprising the step of receiving a verification of a communication originator prior to conveying information stored in a personal information manager.

12. The method of claim of claim 1 wherein the customized notification generated comprises an audio message generated via a text to speech engine.

13. The method of claim 11 wherein the text comprises at least one of an identifying name and telephone number.

14. The system of claim 1 wherein the customized notification generated comprises withholding any indication of notification.

15. Computer executable program code residing on a computer-readable medium, the program code comprising instructions for causing a computerized device to:
receive information descriptive of a communication originator into a data structure;
receive information relating to a calendar event into the data structure;
receive an indication of an incoming communication; and
provide a customized response relating to the incoming communication, wherein the response is customized according to at least one of a) the calendar event or b) the communication originator.

16. The computer executable program code of claim 15 wherein the computerized device comprises a personal communication device.

17. The computer executable program code of claim 15 wherein the program code additionally comprises instructions for causing the computerized device to provide a customized notification signaling receipt of the incoming communication.

18. The method of claim 15 wherein the customized response to an incoming communication comprises conveying to the originating party information stored in a personal information manager associated with a user to whom the incoming communication is directed.

19. A system for facilitating a wireless communication comprising:
a means for receiving data descriptive of a calendar event, wherein the data comprises a notification profile;
a means for storing the received data descriptive of the calendar event;
a means for receiving an indication of an incoming communication;
a means for generating a notification according the received data descriptive of a calendar event and one or more of a) time b) date and c) party originating the communication; and
a means for generating a response to a communication originator according to received data descriptive of a calendar event and one or more of a) time b) date and c) party originating the communication.

20. The system of claim 19 wherein the communication comprises a voice call.

21. The system of claim 19 wherein the communication comprises an alphanumeric text message.

22. The system of claim 19 wherein the notification generated comprises one or more of a) a specified ring volume b) a specified ring tone c) a specified ring pattern d) a vibration and e) a visual indicator.
